(19) United States
(12) Patent Application Publication
(10) Pub. No.: US 2017/0146442 A1
(43) Pub. Date: May 25, 2017

(54) BIOMIMETIC LIQUID PARTICLES, METHOD AND DEVICE FOR FLOW CYTOMETER MEASUREMENT

(71) Applicant: ECOLE SUPERIEURE DE PHYSIQUE ET DE CHIMIE INDUSTRIELLES DE LA VILLE DE PARIS, PARIS (FR)

(72) Inventors: Philippe Marc NERIN, Assas (FR); Nicolas BREMOND, PARIS (FR); Jérôme BIBETTE, PARIS (FR); Jean BAUDRY, PARIS (FR); Rory GILES, Somerset (GB)

(73) Assignee: Ecole Superieure de Physique et de Chimie Industrielles de la Ville de Paris, Paris (FR)

(21) Appl. No.: 15/319,512

(22) PCT Filed: Jun. 16, 2015
(86) PCT No.: PCT/EP2015/063496

§ 371 Date: Dec. 16, 2016

(30) Foreign Application Priority Data
Jun. 17, 2014 (FR) 14 55555

(51) Int. Cl. G01N 15/14; G01N 15/10

(52) U.S. Cl. CPC G01N 15/14; G01N 15/1012; G01N 2015/0065

(57) ABSTRACT

The present invention relates to the use of a solution of liquid particles in suspension for the control, calibration and/or performance of physical, in particular optical, measurements in a flow cytometry device for analysis of biological cells, said solution comprising liquid particles (21) of a first liquid phase dispersed in a second liquid phase, said liquid particles (21) having physical, chemical and/or biochemical properties that enable the attainment of physical measurements in said flow cytometry device similar to measurements obtained with biological cells, and said liquid particles (21), having a diameter for which the coefficient of variation within the solution of liquid particles in suspension is less than 10%.

The invention also relates to a measurement method and a flow cytometry device implementing the solution of liquid particles in suspension.

The present invention relates to a solution of suspended biomimetic liquid particles in the form of an emulsion for controlling, calibrating a biological analysis device such as a flow cytometer intended for analyzing biological cells, and/or conducting optical measurements in such a device.

It also relates to a method for carrying out a control, a calibration and/or a measurement in a flow cytometry device, as well as to a flow cytometry device.

The field of the invention is more particularly, but in a non-limiting way that of devices and methods for biological analysis and notably blood analysis.

Techniques for analyzing blood or other biological media by flow cytometry are well known.

Notably techniques are known which give the possibility of carrying out counts and/or identifications of biological cells, such as for example white corpuscles. Generally, their operation is the following.

The blood samples or those of other biological fluids undergo a preparation phase in which they are diluted, mixed with reagents, lyzed.

They are then transferred in an analysis chamber as a sample flow sufficiently spread out (for example with hydraulic confinement or hydrofocussing techniques) so that the cells which it contains cross this analysis chamber separately.

In the systems which apply optical measurements, the flow of cells cross one or a plurality of optical beams (for example beams from lasers).

In order to identify, characterize and/or count cells, different types of physical measurements may be carried out. Mention may notably be made of:
fluorescence measurements, in order to identify for example cells or particular compounds (proteins) which were marked beforehand with a coloring agent or a fluorescent reagent;
volume measurements by the Wallace H. Coulter technique
light scattering or diffraction measurements.

Among the scattering measurements, are found:
low angle scattering measurements (“Forward Scatter Channel”, FSC) which are carried out with a detector close to the axis of the beam emerging from the sample flow;
side scattering measurements (“Side Scatter Channel”, SSC) which are carried out with a detector positioned at right angles relatively to the measurement beam and to the sample flow;

Low angle FSC and side angle SSC scattering measurements are of particular interest since they provide a pair of coordinates which give the possibility of identifying certain types of cells depending on their position in an FSC-SSC diagram. In the FSC-SCC diagram, it is for example possible to identify several families of leukocytes and proceed with differential counting of these biological cells by using “gating” or a specific classification, well known to one skilled in the art.

In order that a cytometer may provide reliable information, it is necessary to calibrate it and to control it. In practice, these operations are periodically carried out during the utilization of the apparatus.

It is notably necessary to calibrate the low angle FSC and side-angle SSC scattering measurements, in order to be able to connect measured values with physical dimensions or other characteristics of cells.

For this, particles in the solid state with a known size of the polymeric type or PMMA (PolyMethyl MethAcrylate) type are used.

These solid particles however have drawbacks. They have optical properties which do not properly mimic the behavior of the objects for which the cytometer is used, i.e. biological cells.

For example, PMMA beads have a refractive index of the order of 1.59. Now this material is used instead and in place of biological cells for which the average refractive index is located around 1.41. Thus, it is not seldom to have to modify or switch the gains subsequently of the detection systems in order to adapt the dynamics of the signals to the studied objects.

Further, in practice it is observed that the use of PMMA beads produces noisy SSC side scattering signals, which strongly limits the efficiency of the calibration.

In order to calibrate and control cytometers in hematology, biomimetic materials are also used which are artificial bloods made by means of natural products: animal bloods, human bloods, fungi. These products are designed for mimicking at best the physico-chemical functions of human bloods in analysis apparatuses in a clinical routine, which have to be controlled twice a day.

These biomimetic materials also have drawbacks. They are difficult to stabilize over long periods, they are sensitive to temperature and they may have sanitary risks according to the origin of the blood used (contamination with hepatitis B, C, HIV, . . . ) viruses).

The object of the present invention is to propose biomimetic materials adapted to the calibration, the control and the making of measurements in flow cytometers which avoid the drawbacks of the materials known for calibration or control of such systems.

The object of the present invention is also to propose biomimetic materials which produce measurements close to those of biological cells in flow cytometers.

The object of the present invention is also to propose biomimetic materials which give the possibility of carrying out calibrations of flow cytometers in a more accurate way.

The object of the present invention is also to propose biomimetic materials which may easily be adapted to different types of calibration.

The object of the present invention is also to propose biomimetic materials which may allow calibration or physical, chemical or biochemical control of a device for analyzing a biological sample.

The object of the present invention is also to propose biomimetic materials which may be used for carrying out specific biological measurements, including notably the dosage of proteins and of antibodies.

The object of the present invention is also to propose a method for calibrating flow cytometers which give the possibility of attaining improved measurement accuracies, notably for identifying cells.

The object of the present invention finally is to propose a flow cytometer which integrates calibration means easy to apply and based on products easy to be stored.

These goals are achieved by using a solution of suspended liquid particles for controlling, calibrating and/or making physical measurements in a biological analysis device,

said solution being characterized in that it comprises liquid particles of a first liquid phase dispersed in a second liquid phase,

said liquid particles have physical and/or biochemical properties giving the possibility of producing in said device for analyzing similar physical measurements to measurements as obtained (or they would be obtained) with said analysis device on biological cells.

The first liquid phase and the second liquid phase comprise liquids which are not miscible with each other. Their mixture therefore produces a compound in the form of a solution of suspended liquid particles, or of an emulsion.

The biological analysis device may notably be a flow cytometry device intended for analyzing biological cells.

The control and the calibration may notably be of a physical or biochemical nature.

The liquid particles may notably have physical and/or biochemical properties giving the possibility of producing in the analysis device optical measurements similar to optical measurements as obtained with said analysis device on biological cells.

According to embodiments, the solution of suspended liquid particles may comprise liquid particles with:
a refractive index of less than 1.5;
a refractive index of less than 1.45;
a refractive index comprised between 1.35 and 1.45;
a refractive index equal to 1.4.

These refractive index values may be determined for a working wavelength comprised between 0.25 μm and 2 μm.

According to embodiments, the suspended particles may comprise liquid particles:
with a diameter of less than 20 μm;
with a diameter comprised between 0.5 and 20 μm;
with a diameter comprised between 1 and 10 μm, preferentially comprised between 4 and 6 μm.

According to embodiments, the solution of suspended liquid particles according to the invention may comprise liquid particles with a diameter for which the variation coefficient within the solution of suspended liquid particles, defined as the ratio between the standard deviation of the distribution of the diameters and the average diameter, is less than 20%, or preferentially less than 10% or 5%.

The diameters of the mentioned liquid particles may be defined as equivalent diameters of a sphere of same volume, or of a sphere forming the best shape approximation, or hydrodynamic diameters, it being understood that anyway the suspended liquid particles have a substantially spherical shape.

Thus, the compound according to the invention has the shape of a solution of suspended particles which comprises liquid so called “monodispersed” particles in the sense that they are very similar and very homogenous within the solution of suspended particles in terms of dimensions and physical characteristics. Further, these liquid particles are designed so as to have physical, chemical or biochemical properties giving the possibility of mimicking, with selected perfection degrees, the response of actual cells within an analysis device, notably a flow cytometer.

In particular, as non-limiting examples in connection with measurements applied usually in a flow cytometer:
the liquid particles of the invention may have physical and/or biochemical properties such as a refractive index and/or a diameter close to those of biological cells (of the leukocyte type for example), so as to produce when they are analyzed in a flow cytometer, diffraction or scattering measurements similar to diffraction or scattering measurements which would be obtained with the same device by analyzing these biological cells;
the liquid particles of the invention may have physical and/or biochemical properties such as a fluorescence intensity at a given wavelength and close to those of biological cells optionally treated beforehand with reagents, so as to produce when they are analyzed in a flow cytometer, fluorescence measurements similar to fluorescence measurements which would be obtained with the same device by analyzing these biological cells;
the liquid particles of the invention may have physical and/or biochemical properties such as an electric impedance at least one electric frequency close to that of biological cells, so as to produce when they are analyzed in a flow cytometer according to the Coulter method, electrical measurements similar to electrical measurements which would be obtained with the same device by analyzing these biological cells.

The term of “similar measurements” refers to measurements producing the same values, or comparable values, or further values which are found in a same predetermined interval, or further measurements representative of a same type and/or of a same condition of biological cells.

According to embodiments of the solution of suspended liquid particles according to the invention, the first liquid phase may comprise at least one of the following compounds:
a mineral or vegetable oil,
a silicone or polysiloxane oil
a solution of carbon sulfide CS₂,
an organic solvent from the family of alkanes,
hexane,
pentane,
a fluorocarbon oil.

The second liquid phase of the solution of suspended liquid particles according to the invention may comprise water and:
amphiphilic molecules, notably anionic molecules (sodium dodecylsulfate (SDS), sodium oleate, . . . ), cationic molecules (cetyltrimethyl ammonium bromide (CTAB), . . . ), non-ionic molecules (poly(oxyethylene) sorbitan monolaurate, polyethylene glycol distearate, a block copolymer of poly(ethylene glycol)-poly(propylene glycol), . . . ); and/or
solid nano-particles of a sub-micrometric size, able to be adsorbed at the interface between two liquid phases.

The amphiphilic molecules (or surfactants, or surface agents, or tensides) or nano-particles notably give the possibility of stabilizing the liquid particles which are suspended drops, against merging or aggregation or ripening of the drops together, and thereby give the possibility of guaranteeing the stability over time of the solution of suspended particles.

According to embodiments of the present invention, the liquid particles may include at least one of the following elements:
a fluorophore,
solid or liquid micro-particles,
gold particles coupled with lipophilic molecules,
amphiphilic molecules,
a functionalized ligand with one molecule having great affinity for the first phase and having amphiphilic properties.

The organic solvents from the family of alkanes such as hexane or pentane notably give the possibility of solubilizing fluorescent compounds such as fluorophores produced by Hoechst® (Hoechst 33258, Hoechst 33342 and Hoechst 34580).

The micro-particles are particles with a smaller size than those of the liquid particles.

Micro-particles with gold particles coupled with lipophilic molecules may give the possibility of significantly increasing the large angle scattering signal (side scattering SSC) without notoriously modifying the low angle scattered intensity (FSC scattering) during measurements carried out in a flow cytometer.

As explained earlier, it is possible to incorporate into the liquid particles of the invention, ligands themselves attached to a molecule having a great affinity for the fractionated phase, i.e. the liquid particle, so that the ligand-molecule complex has a shared affinity between the phase making up the liquid particle and the phase in which is found the particle. In other words, it is possible to incorporate functionalized amphiphilic molecules.

Unlike the solid particles of the prior art, for which the ligands are <<attached>> to the surface of the particles through a covalent bond, the ligands are here trapped at the surface of the liquid particles, notably via an amphiphilic molecule. Further, they have a mobility at the periphery of the liquid particle which gives the possibility of efficiently capturing at its interface, receptors of interest.

In the case of the solid particles of the prior art, for which the ligand is set at the surface of the particle, a large number of ligands have a random orientation which does not allow them to capture the receiving molecule of interest: this is the case of antibodies for which the conventional grafting techniques do not allow selection of their orientation, and those which are not properly oriented cannot capture the antigen.

In the case of the liquid particle of the invention, the ligands are in permanent motion at the actual periphery of the particle by the effect of the Brownian motion. The ligands may potentially have all the possible orientations, and capture at the interface, i.e. at the frontier between the first phase and the second phase, the molecule of interest in an optimal way, since theoretically all the orientations of the ligand are possible.

Further, an accumulative effect is obtained with the invention, which gives the possibility of concentrating the ligand-receptor complex at the surface of the liquid particle. Indeed, potentially, all the ligands present in a liquid particle may capture a molecule of interest. It is thus possible to obtain a higher concentration of molecules of interest on the liquid particles than in the continuous phase. This characteristic is very advantageous notably for identifying and dosing “receptor” molecules weakly abundant in the continuous phase.

According to another aspect, a method is proposed for carrying out control, calibration and/or measurement in a flow cytometry device intended for the analysis of biological cells, which comprises steps:
for transferring into said flow cytometry device a solution of suspended liquid particles comprising liquid particles from a first liquid phase dispersed in a second liquid phase, which liquid particles have physical, chemical and/or biochemical properties giving the possibility of producing in said flow cytometry device physical measurements similar to measurements obtained with biological cells,
for conducting measurements of at least one of the following types on said liquid particles: optical measurements, electrical measurements, magnetic measurements, electromagnetic measurements.

According to embodiments, the method according to the invention may further comprise steps:
for mixing a solution of suspended liquid particles comprising liquid particles with ligands able to bind to molecules of interest with a solution containing molecules of interest, so as to allow capture at the surface of liquid particles by the ligands of molecules of interest,
for inferring a piece of information on said molecules of interest from optical measurements on said liquid particles.

The method according to the invention may also comprise steps:
for measuring fluorescence,
for inferring a piece of information on the density of the molecules of interest present at the surface of the liquid particles. This piece of information may notably be a fluorescence intensity proportional to the concentration of the ligand-receptor-fluorophore complex, in a technique for assaying the molecule of interest: antigen, ion, enzyme, . . .

According to embodiments, the method according to the invention may further comprise steps:
for low angle scattering measurements (FSC) and side scattering measurements (SSC) on liquid particles of a known dimension,
for inferring a piece of information for calibration of the cytometer for differentiation or measurement of dimensions of cells.

Indeed, as the characteristics of the liquid particles of the invention are known and controlled, and further close to those of biological cells to be characterized, it is thereby possible to calibrate the response of a flow cytometer for scattering measurements FSC-SSC-Volume so that they subsequently produce specific and reliable information on the biological cells.

According to embodiments, the method according to the invention may further comprise steps:
for measuring fluorescence on liquid particles comprising at least one fluorophore,
for inferring a piece of information of calibration of the cytometer for fluorescence measurements.

Thus, by including in the liquid particles of the invention fluorophores with a known concentration, it is possible to simulate biological cells with fluorescent markers and therefore calibrate channels for measuring fluorescence of a cytometer.

According to still another aspect, a flow cytometry device is proposed, intended for analyzing biological cells, said device comprise application means, for controlling, calibrating and/or conducting physical measurements, notably optical measurements, of a solution of suspended liquid particles comprising liquid particles from a first liquid phase dispersed in a second liquid phase, which liquid particles have physical, chemical and/or biochemical properties giving the possibility of producing in said flow cytometry device physical measurements similar to measurements obtained with biological cells.

According to embodiments, the flow cytometry device of the invention may further comprise means for producing the solution of suspended liquid particles from fluids of the first phase and of the second phase respectively.

It may notably comprise dispersion means based on a microfluidic technology for producing the solution of suspended liquid particles, which microfluidic technology applying at least one of the following configurations:
a joint flow of the fluids of the first phase and of the second phase,
transverse flows of the fluids of the first phase and of the second phase,
a flow of one of the two fluids of one of the phases through a hole opening into a tank containing the other fluid of the other phase,
channels in which flow both fluids simultaneously having a variation in their dimensions, such as height or width.

According to embodiments, the flow cytometry device of the invention may further comprise means for separately storing at least one fluid of the first phase and at least one fluid of the second phase.

Thus, advantageously, it is not necessary to store and transport a solution of suspended liquid particles according to the invention.

The products entering the composition of the first liquid phase and of the second liquid phase may be brought and stored separately in the flow cytometry apparatus or nearby like conventional reagents. This gives the possibility of avoiding possible problems related to the stability overtime of the suspended liquid particles. This also gives the possibility of easily producing and on demand, liquid particles with different characteristics (inclusion of specific fluorophores, . . . ).

These advantages in terms of use are of course due to the nature of the calibration product, i.e. of the solution of suspended liquid particles according to the invention.

Further, as mentioned earlier, the synthesis of the liquid particles may be easily achieved with a production method which relies on microfluidic technologies. It is thus possible to produce a device for producing a solution of suspended particles which is compatible with integration into a laboratory flow cytometer, and which is able to produce volumes of solution of suspended liquid particles required for the calibration and/or control of the flow cytometer.

The production methods which may be used within the scope of the invention notably comprise those which involve:
joint flow of two immiscible fluids with or without focussing of the immiscible fluids, with or without variation in the geometry of the channels in which flow both fluids simultaneously,
transverse flows of both immiscible fluids with or without variation in the geometry of the channels in which flow both fluids,
a flow of one of the two immiscible fluids through a hole with a rectangular section and opening into a tank containing the second fluid at rest or else flowing.

Other advantages and particularities of the invention will become apparent upon reading the detailed description for application and of embodiments which are by no means limiting, and of the following appended drawings:

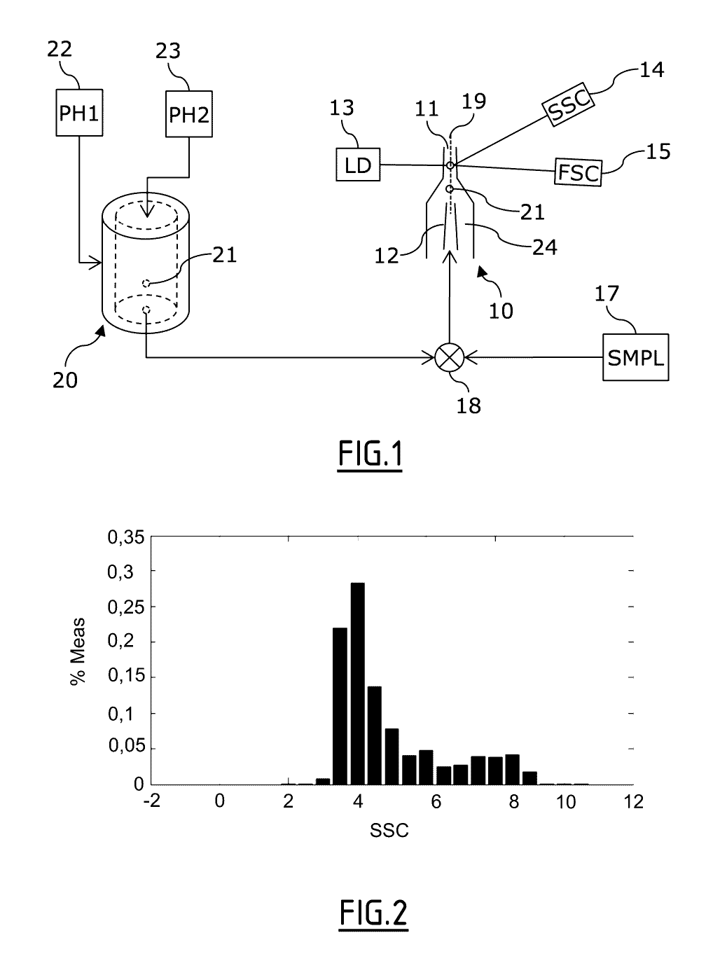

FIG. 1 shows an embodiment of a flow cytometer according to the invention which allows low angle scattering measurements (FSC) and side scattering measurements (SSC) on cells,

FIG. 2 shows a histogram of measurements of a measurement signal SSC obtained with polymer spheres with a diameter of 5 μm on a flow cytometer applying a laser at a wavelength of 488 nm,

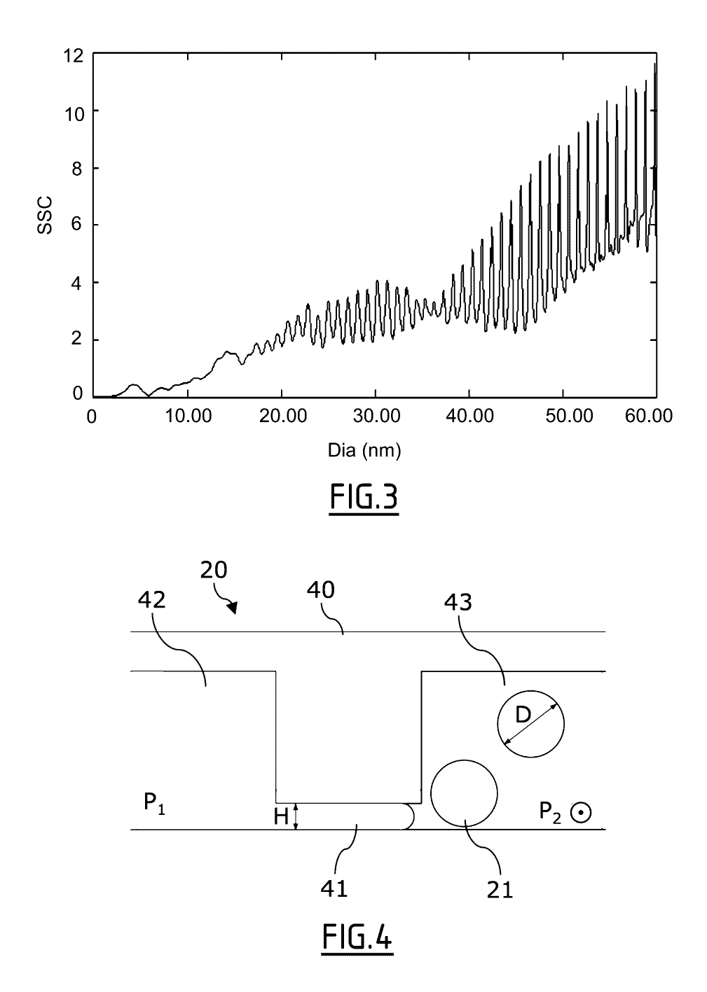

FIG. 3 shows the intensity of a measurement signal SSC obtained at a wavelength of 488 nm on polymer spheres, according to the diameter of these spheres,

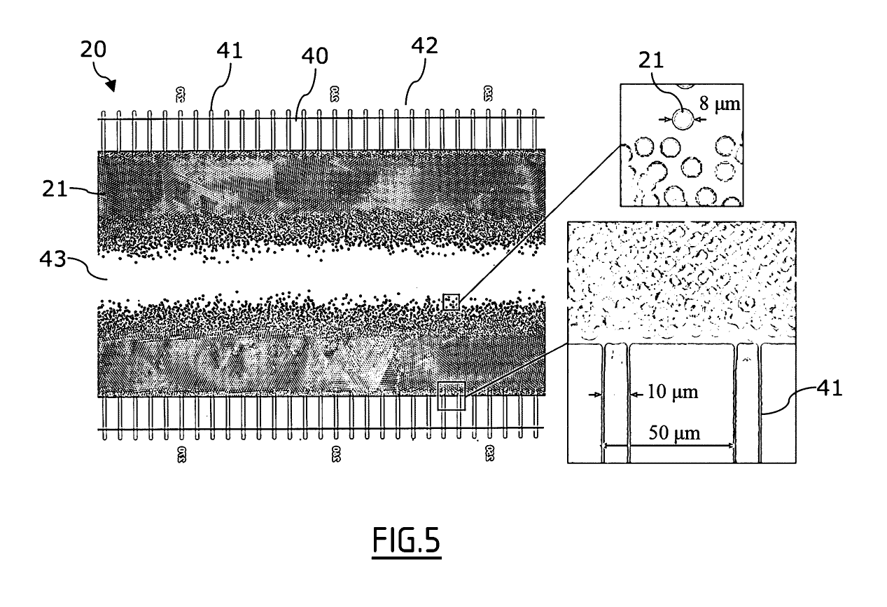

FIG. 4 shows a basic diagram of a device for producing liquid particles according to the invention,

FIG. 5 shows a sectional view of a device for producing liquid particles according to the invention,

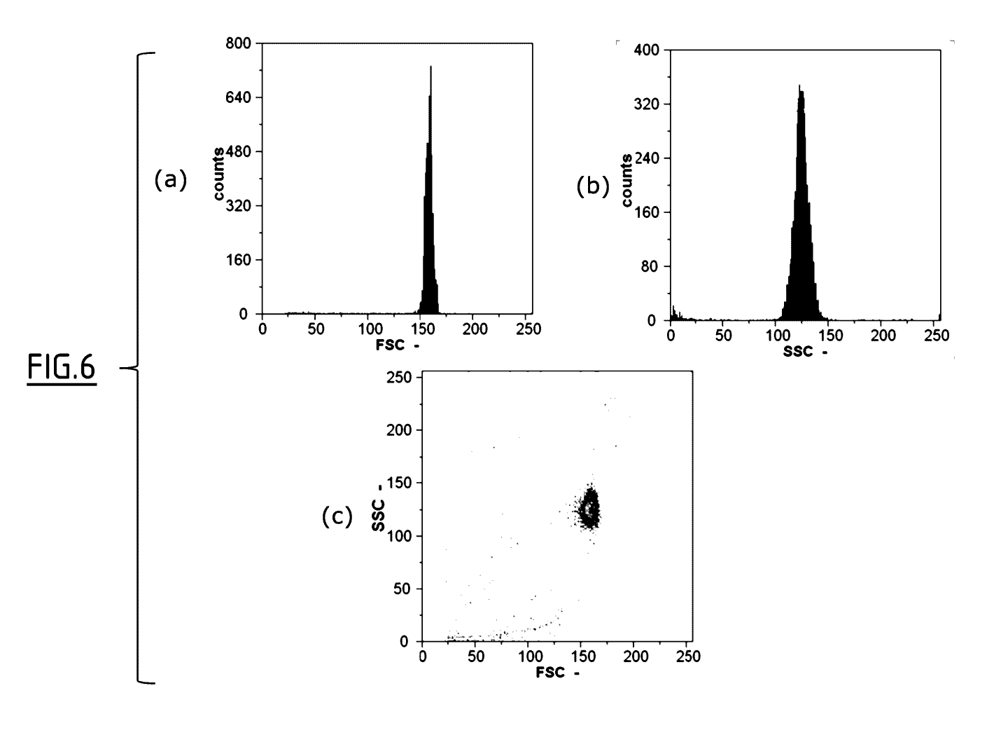

FIG. 6 shows results obtained with a flow cytometer by applying the calibration method of the invention, with FIG. 6a, a histogram of low angle scattering measurements (FSC), FIG. 6b, a histogram of side scattering measurements (SSC) and FIG. 6c the corresponding SSC-FSC diagram,

FIG. 7 shows an example of fluorescence measurements obtained with a flow cytometer on fluorescent liquid particles according to the invention,

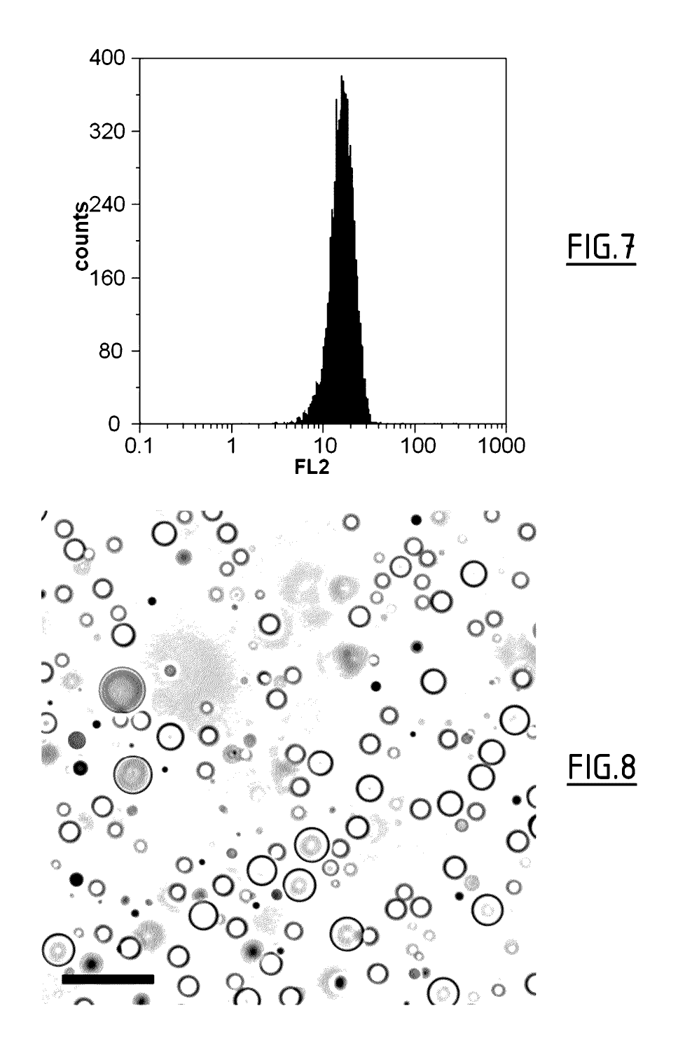

FIG. 8 shows a photograph taken under a microscope (scale bar=20 μm) of a solution of liquid particles, prepared beforehand with a mortar and having a variation coefficient of more than 10%, and

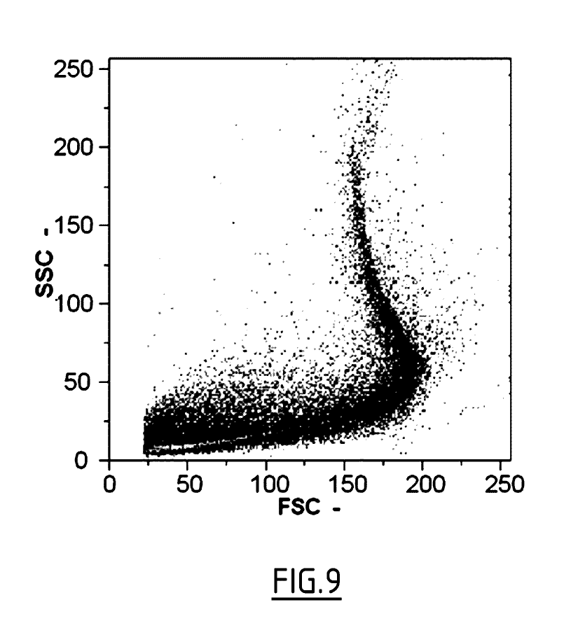

FIG. 9 shows the SSC-FSC diagram obtained with the comparative solution of FIG. 8 and the flow cytometer used within the scope of FIG. 7.

It is quite understood that the embodiments which will be described in the following are by no means limiting. Alternatives of the invention may notably be devised only comprising a selection of characteristics described subsequently isolated from the other described characteristics, if this selection of characteristics is sufficient for giving a technical advantage or for differentiating the invention relatively to the state of the prior art. This selection comprises at least relatively to the state of the prior art, this selection comprises at least one preferably functional characteristic without structural details, or with only one portion of the structural details if this portion is exclusively sufficient for giving a technical advantage or for differentiating the invention relatively to the state of the prior art.

In particular all the alternatives and all the embodiments described may be combined with each other if nothing opposes this combination technically.

In the figures, the elements common to several figures retain the same reference.

With reference to FIG. 1, the invention relates to a method for calibrating flow cytometers intended to carry out measurements on biological cells, notably.

Such instruments are for example currently used for carrying out blood analyses, countings of cells such as leukocytes . . .

Generally, a flow cytometer comprises an analysis chamber 10 at which the measurements are carried out.

The samples of blood or of other biological fluids 17 are subject to a preparation phase in which they are diluted, mixed with reagents, lyzed . . .

They are then transferred into the analysis chamber 10 and conditioned as a sample flow 19 which is sufficiently fine and spread out so that the cells which it contains cross a measurement area 11 so as to be able to be distinguished.

In the embodiment shown in FIG. 1, the conditioning of the sample flow 19 is achieved by applying a hydraulic confinement technique, or “hydro-focussing”. The sample flow 19 is injected into the analysis chamber through an injection nozzle 12. A sheath fluid 24 is also injected into the analysis chamber 10 around the injection nozzle 12. This sheath fluid 24 is used for stretching and centering the sample flow 19.

The thereby conditioned sample flow 19 crosses a measurement area 11. This measurement area 11 notably comprises means for optical measurements. Of course, other known measurement means, such as means for measuring impedance, may also be applied.

The optical measurement means give the possibility of generally carrying out optical measurements of the type of fluorescence measurements and/or scattering measurements at various angles.

They therefore comprise at least one light source 13 (generally a laser diode) which generates an optical measurement beam directed towards the sample flow 19 in the measurement area 11. Photodetectors are positioned according to different angular orientations for capturing the light stemming from the sample flow and due to scattering or fluorescence phenomena.

The embodiment shown in FIG. 1 illustrates a measurement configuration with:
a photodetector 15 positioned along an optical axis close to the optical axis of the measurement beam, which gives the possibility of conducting low angle scattering measurements (FSC);
a photodetector 14 positioned along an optical axis substantially at right angles relatively to the optical axis of the measurement beam and to the sample flow 19, which gives the possibility of carrying out side scattering measurements (SSC).

The fluorescence measurements are for example used for identifying cells or particular compounds (proteins) which have been marked beforehand with a coloring agent or a fluorescent reagent.

As explained earlier, the low angle scattering measurements FSC and side scattering measurements SSC are particularly of interest since they provide a pair of coordinates which gives the possibility of identifying certain types of cells depending on their position in a FSC-SSC intensity diagram. It is notably possible to identify leukocytes in this way.

In order that a cytometer may provide reliable information, it is necessary to calibrate it and to control it. In practice, these operations are carried out periodically during the utilization of the apparatus.

It is notably necessary to calibrate the low angle scattering measurements FSC and side scattering measurements SSC, in order to be able to connect measured values to physical dimensions or other characteristics of cells.

For this, instead of the sample flow 19, one let through a calibration flow which contains particles or microbeads 21 of known dimensions.

In the method of the prior art, particles in the solid state, for example of the polymer PMMA (polymethyl methacrylate) type. The results are not however satisfactory.

Indeed, even by using microbeads with very homogenous dimensions, a strong dispersion of the measured side scattering intensities SSC is observed.

This effect is illustrated in FIG. 2 which shows a histogram of side scattering measurements SSC carried out at a wavelength of 488 nm on PMMA microbeads with a diameter of 5 μm and for which the volume variation coefficient within the sample is 1.5%.

A dispersion of the measurements is observed, which is much greater than the dispersion of the particles in terms of size. This dispersion of the measurements of course has a direct impact on the quality of the calibration and on the measurements carried out subsequently with the apparatus.

With reference to FIG. 3, it was determined within the scope of the invention that this dispersion of side scattering measurements SSC may be explained by Mie's theory and notably comes from the fact that the refractive index of the particles used in a polymeric material is too high.

The curve of FIG. 3 represents an intensity, calculated at a wavelength of 488 nm, of the side scattering signal SSC depending on the diameter of a polymer particle comprised between 0 and 6 μm. The polymer taken into account is PMMA with a refractive index of the order of 1.59.

As shown by this curve, there exist significant oscillations. These oscillations result from the superposition of multiple waves (stemming from reflections and/or multiple transmissions within the sphere) the sum of which involves amplitudes with a phase factor which depends on the refractive index and on the diameter of the particle. The amplitude of the oscillations is close to 50% for 5 μm particles, which explains the dispersion of measurements observed in practice and illustrated in FIG. 2.

Within the scope of the invention it was also determined that these oscillations of the curve of 3 are not found or at the very least are very strongly attenuated by carrying out the same calculations with particles which have a refractive index close to that of biological cells, i.e. of the order of 1.41.

Thus, within the scope of the invention, a compound was developed which allows best simulation of the behavior of biological cells in terms of optical measurement results in a flow cytometer.

This compound is notably intended to allow much more accurate calibration of these flow cytometers.

As explained earlier, this compound is a solution of suspended liquid particles. The particles are made as liquid particles or drops of a first liquid phase suspended in a second liquid phase. The liquids of the first and of the second phase are of course non-miscible. This compound may therefore be considered as an emulsion.

In order to obtain optimum calibration performances, it was established that the rated size of the liquid particles should be located at 5 and 6 μm with a refractive index equal to 1.4. Of course, the variation coefficient of the size of the liquid particles within the solution of suspended particles should be as reduced as possible (for example of the order of 10% in diameter, preferentially of the order of 5%).

According to an embodiment, the first phase is obtained with an optical index oil. Index optical oils are oils which are specifically formulated so as to have a known optical refractive index and controlled. Such oils are currently used in optics for producing refractive index adaptation layers notably. Mention may notably be made of the oils produced by Cargille®.

In the embodiment shown, the second phase consists of water and of sodium dodecylsulfate (SDS), which gives the possibility of ensuring the stability of the solution of suspended particles over time.

As explained earlier, it is also possible to include in the first phase additional elements such as fluorophores, micro-particles or ligands.

This inclusion should of course be carried out before mixing both phases as a solution of suspended particles.

With reference to FIGS. 4 and 5, we shall now describe a production device 20 which gives the possibility of producing a solution of suspended particles according to the invention.

This production device 20 applies a microfluidic method which allows bulk manufacturing of liquid particles 21, i.e. of the order of 10 mL/day for liquid particles 21 for which the diameter is comprised between 1 and 10 μm.

It comprises a body 40 (for example in glass) with a plurality of micro-channels with a rectangular section 41 crossing its wall. FIG. 5 shows a sectional view of this body 40.

The liquid of the first phase 42 is brought into contact with the external face of the body 40 with a pressure P1.

The liquid of the second phase 43 is brought into contact with the internal face of the body 40 with a pressure P2.

As illustrated in FIG. 4, under the effect of a pressure difference, the liquid of the first phase 42 flows through the liquid of the second phase 43 through micro-channels 41 while fragmenting as drops or liquid particles 21.

For a micro-channel, the diameter D of the thereby formed liquid particles and their formation frequency f notably depend on the thickness H of the micro-channel and of the flow rate Q of the liquid of the first phase in this micro-channel:

Q=πD3f/6.

Moreover, the formation frequency f depends very little on the pressure P2 on the side of the second phase but increases with the pressure P1 on the side of the first phase.

Thus on the side of the second phase 43 inside the body 40 a monodispersed solution of suspended particles of liquid particles of the first phase 42 is obtained with very homogeneous dimensions (size of the drops=8 μm and variation coefficient=4%) distributed in the second phase 43. The solution of suspended particles gradually flows during its formation towards an outlet of the body 40.

FIG. 6 shows results of calibration of a flow cytometer obtained with a solution of suspended particles for calibration according to the invention.

FIGS. 6a and 6b respectively show histograms of low angle scattering measurements (FSC) and side scattering measurements (SSC), obtained for a population of liquid particles according to the invention. It is seen that the strong dispersion of the side scattering measurements (SSC) observed in FIG. 2 for PMMA microspheres has disappeared in the side scattering measurements carried out with the liquid particles of the invention (FIG. 6b). Accordingly, as illustrated in FIG. 6c, the calibration population of liquid particles produces a well-localized “spot” in the SSC-FSC diagram which gives the possibility of efficiently calibrating the relationship between the FSC-SSC measurements and the sizes or other characteristics of biological cells.

FIG. 7 shows an example of fluorescence measurements obtained with a flow cytometer on fluorescent liquid particles according to the invention.

The phase dispersed as drops or droplets (the first phase) comprises a mineral oil and a fluorophore of the “Nile red” type with a concentration of the order of 2·10⁻⁵ mol/l. The second phase consists of water and of sodium dodecylsulfate (SDS).

The solution of suspended particles, formed as explained earlier, is sufficiently stable over time so as to be able to be produced in mass, conditioned in flasks and forwarded to the final users for a routine use in laboratory flow cytometers.

Thus it is possible to use the solution of suspended particles and the calibration method of the invention for improving the calibration of any type of existing flow cytometer, a solution as a replacement of other calibration product.

The solution of liquid particles of FIG. 8 was obtained by mixing in a mortar the aforementioned first phase liquid and second phase liquid. The chemical composition of this solution of liquid particles is therefore identical with that of the solution of liquid particles prepared according to FIG. 5.

Unlike the solution of liquid particles prepared according to FIG. 5, the solution of liquid particles of FIG. 8 is polydispersed (variation coefficient=75%) and essentially consisting of drops of the order of one micrometer (average diameter of the drops=2.3 μm).

Unlike the SSC-FSC diagram of FIG. 6c obtained with a solution of liquid particles according to the invention (FIG. 5), the SSC-FSC diagram of FIG. 9 shows that the comparative solution of polydispersed liquid particles produces a “spot” very spread out, which does not allow efficient calibration of the apparatus.

According to another advantageous aspect, the invention also allows cytometers to be made with integrated calibration means.

FIG. 1 thus illustrates a flow cytometer according to the invention which comprises a device 20 for producing a solution of suspended liquid particles, for example as described in FIGS. 4 and 5.

This flow cytometer according to the invention also comprises means 22 for storing liquid(s) of the first phase 42 and means 23 for storing liquid(s) of the second phase 43.

In practice, these storage means 22, 23 may comprise flasks and interfaces for inserting these flasks into the cytometer, as this is conventionally accomplished for the reagents.

Additional products (fluorophores, . . . ) may also be stored at the apparatus for producing solutions of suspended particles with particular properties.

The solution of suspended particles is produced depending on the needs in the integrated production device 20.

The cytometer may also optionally comprise a temporary storage of the produced solution of suspended particles.

In the embodiment shown, the flow cytometer according to the invention comprises a valve 18 which gives the possibility of bringing towards the measurement chamber 24, either the solution of suspended liquid particles, or biological samples prepared in a customary way.

This embodiment therefore gives the possibility of bringing and storing at the cytometer only the products required for the manufacturing of the solution of suspended liquid particles. Further, they may be handled like other conventional reagents.

As explained earlier, the solution of suspended liquid particles according to the invention may also be used for “capturing” and concentrating molecules of interest at the surface of the liquid particles 21.

In this case, the solution of suspended liquid particles according to the invention is used as an element for calibration or dosage of a molecule of interest.

A measurement method is then applied which comprises steps:
for applying or manufacturing a suitable solution of suspended particles, with ligands included in the liquid particles 21;
for diluting the solution of suspended liquid particles into a solution containing the molecules of interest, so that the molecules of interest are captured and concentrated at the surface of the liquid particles 21;
for transferring the solution of suspended liquid particles into the measurement chamber 10 of the cytometer in order to carry out measurements, notably fluorescence measurements, on the liquid particles 21;
for inferring a piece of information on the molecules of interest such as a presence (detection) or a concentration on the basis of the processing of the measurements, notably fluorescence measurements.

This type of measurements may of course advantageously be carried out with a cytometer according to the invention with an integrated device 20 for producing a solution of suspended liquid particles. In this case, provision has to be simply made of additional dilution means for the solution of suspended particles with a solution containing molecules of interest.

Of course, a solution of suspended liquid particles according to the invention (according to a same formulation or according to different formulations) may be used in a same flow cytometer for carrying out:
calibration measurements,
measurements on molecules of interest.

The molecules of interest are for example antibodies comprised in the reagents of flow cytometers allowing the marking of biological cells such as anti-CD4 and/or CD8 antibodies, but theoretically the fluid particle may contain at least one ligand giving the possibility of recognizing an anti-CDn (wherein n is an integer giving the possibility of identifying the molecule of interest according to a classification well known to one skilled in the art) antibody.

According to embodiments, the calibration method according to the invention may be applied with any type of flow cytometers.

It may notably be applied with flow cytometers which apply any type of confinement method for generating a sample flow 19. It may thus be applied for example with flow cytometers which use fluidic micro-channels for confining the sample flow 19 without any cladding fluid.

It may also be applied with flow cytometers intended for carrying out measurements on elements other than biological cells, or on non-biological elements.

Also, a flow cytometer according to the invention which comprises calibration means as described earlier may:
be of any type;
apply any type of confinement method;
be intended for carrying out measurements on elements other than biological cells or on non-biological elements.

According to the embodiments, a device 20 for producing a solution of suspended liquid particles may also be shared among several flow cytometers.

Of course, the invention is not limited to the examples which have just been described and many arrangements may be provided to these examples without departing from the scope of the invention. For example, the liquid particles may be mixed with biological particles (erythrocytes, spores) in order to allow, in a single phase, calibration and/or control of the functions that only biomimetic particles may satisfy like the activity of a lytic reagent currently used in flow cytometers.

1. The use of a solution of suspended liquid particles for controlling, calibrating and/or conducting physical measurements in a biological analysis device,
said solution comprising liquid particles (21) of a first liquid phase (42) dispersed in a second liquid phase (43),
said liquid particles (21) having physical, and/or biochemical properties allowing production in said device for analyzing physical measurements similar to measurements as obtained with said analysis device on biological cells, and
said liquid particles (21) having a diameter for which the variation coefficient within the solution of suspended liquid particles is less than 10%.

2. The use according to claim 1, wherein said solution comprises liquid particles (21) with a refractive index of less than 1.5.

3. The use according to claim 1, wherein said solution comprises liquid particles (21) with a diameter comprised between 0.5 and 20 μm.

4. The use according to claim 1, wherein the liquid particles (21) have a diameter for which the variation coefficient within the solution of suspended liquid particles is less than 5%.

5. The use according to claim 1, wherein the first liquid phase (42) comprises at least one of the following compounds:
a mineral or vegetable oil,
a silicone or polysiloxane oil,
a solution of carbon sulfide CS₂,
an organic solvent from the family of alkanes,
hexane,
pentane,
a fluorocarbon oil.

6. The use according to claim 1, wherein the second liquid phase (43) comprises water and:
amphiphilic molecules; and/or
solid nano-particles of a sub-micron size, capable of being adsorbed at the interface between both liquid phases.

7. The use according to claim 1, wherein the liquid particles (21) includes at least one of the following elements:
a fluorophore,
solid or liquid micro-particles,
gold particles coupled with lipophilic molecules,
amphiphilic molecules,
a functionalized ligand to a molecule having a great affinity for the first phase and having amphiphilic properties.

8. A method for carrying out a control, a calibration and/or a measurement in a flow cytometry device intended for analyzing biological cells, characterized in that it comprises steps:
for transferring into said flow cytometry device a solution of suspended liquid particles comprising liquid particles (21) of a first liquid phase (42), dispersed in a second liquid phase (43), said liquid particles (21) having physical, chemical and/or biochemical properties giving the possibility of producing in said flow cytometry device physical measurements similar to measurements obtained with biological cells, and said liquid particles (21) having a diameter for which the variation coefficient within the solution of suspended liquid particles is less than 10%,
for conducting measurements of at least one of the following types on said liquid particles (21): optical measurements, electrical measurements, magnetic measurements, electromagnetic measurements.

9. The method according to claim 8, further comprising steps:
for mixing a solution of suspended liquid particles comprising liquid particles (21) with molecules of ligands capable of binding to molecules of interest with a solution containing molecules of interest, so as to allow capture at the surface of liquid particles by the ligands of molecules of interest,
for inferring a piece of information on said molecules of interest from optical measurements on said liquid particles (21).

10. The method according to claim 9, comprising steps:
for fluorescence measurements,
for inferring a piece of information on the density of molecules of interest present at the surface of the liquid particles (21).

11. The method according to claim 8, comprising steps:
for low angle scattering measurements (FSC) and side scattering measurements (SSC) on liquid particles (21) of a known size,
for inferring a piece of calibration information of the cytometer for differentiation of cells.

12. The method according to claim 8, comprising steps:
for fluorescence measurements on liquid particles (21) comprising at least one fluorophore,
for inferring a piece of calibration information of the cytometer for fluorescence measurements.

13. A flow cytometry device intended for the analysis of biological cells, characterized in that it comprises means for applying, for controlling, calibrating and/or conducting physical measurements, for a solution of suspended liquid particles comprising liquid particles (21) of a first liquid phase (42) dispersed in a second liquid phase (43), said liquid particles (21) having physical, chemical and/or biochemical properties giving the possibility of producing in said flow cytometry device physical measurements similar to measurements obtained with biological cells, and said liquid particles (21) having a diameter for which the variation coefficient within the solution of suspended liquid particles is less than 10%.

14. The device according to claim 13, further comprising means (18, 20, 22, 23) for producing the solution of suspended liquid particles from fluids of the first phase (42) and of the second phase (43) respectively.

15. The device according to claim 14, comprising dispersion means (20) based on a microfluidic technology for producing the solution of suspended liquid particles, which microfluidic technology applying at least one of the following configurations:
joint flow of the fluids of the first phase (42) and of the second phase (43),
transverse flows of the fluids of the first phase (42) and of the second phase (43),
a flow of one of the two fluids of one of the phases through a hole opening into a tank containing the other phase,
channels in which flow both fluids simultaneously having a variation of their dimensions, such as the height or width.

16. The device according to claim 13, further comprising means (22, 23) for storing separately at least one fluid of the first phase (42) and at least one fluid of the second phase (43).
